(19) United States
(12) Patent Application Publication
(10) Pub. No.: US 2013/0153747 A1
(43) Pub. Date: Jun. 20, 2013

(54) INPUT DEVICE

(71) Applicant: Samsung Electro-Mechanics Co., Ltd., Gyunggi-do (KR)

(72) Inventors: Victor YURLOV, Gyunggi-do (KR); Ho Seop JEONG, Gyunggi-do (KR); Seong Woo KIM, Gyunggi-do (KR); Chul CHOI, Gyunggi-do (KR); Ju Sung PARK, Gyunggi-do (KR); Kwang Yun CHOI, Gyunggi-do (KR)

(73) Assignee: SAMSUNG ELECTRO-MECHANICS CO., LTD., Gyunggi-do (KR)

(21) Appl. No.: 13/670,919

(22) Filed: Nov. 7, 2012

(30) Foreign Application Priority Data
Dec. 16, 2011 (KR) 10-2011-0136354

(51) Int. Cl. G01J 1/44

(52) U.S. Cl. 250/206

(57) ABSTRACT

There is provided an input device including: a housing having a surface on which a plurality of grids are disposed; a light emitting unit irradiating light onto the surface of the housing; a light receiving element detecting the light irradiated from the light emitting unit and reflected from the surface; and a control unit determining information regarding an object contacting the surface from the light detected by the light receiving element.

### CROSS-REFERENCE TO RELATED APPLICATIONS

This application claims the priority of Korean Patent Application No. 10-2011-0136354 filed on Dec. 16, 2011, in the Korean Intellectual Property Office, the disclosure of which is incorporated herein by reference.

### BACKGROUND OF THE INVENTION

1. Field of the Invention

The present invention relates to an input device capable of sensing an input without a separate lens or an image sensor, by sensing a reflection of light irradiated onto a surface having a grid or an optical filter from a light emitting unit and determining input information regarding a contacted object.

2. Description of the Related Art

As mobile electronic apparatuses such as smart phones, personal digital assistants (PDAs), tablet PCs, and the like are becoming increasingly popular, research into input devices easily accessible to users while having a limited form factor has been actively conducted. A representative mobile electronic apparatus may be a touch screen integrally implemented with a display device and providing users with a convenient input environment, without a separate mechanical keypad.

A micro-sized mouse apparatus, along with the touch screen, is increasingly being applied to mobile electronic apparatuses. The micro-small sized mouse apparatus is implemented to be micro-sized in such a manner that a mouse generally applied to a desktop computer can be mounted on a mobile electronic apparatus, providing a limited area as an input space for receiving a user's input, as well as sensing, determining, and processing a movement of the user's input, for example, a finger contact, or the like, as light or pressure.

A micro-sized mouse-type input device using light has advantages in that it may have a long lifespan and determine a minute input, as compared to a mechanical input device or a device using a pressure sensor like a tracking ball. However, the micro-sized mouse-type input device requires a lens for collecting light or a laser light emitting apparatus having excellent straightness for exact input recognition, which increases the price and overall size of an entire module, and thus it is difficult to advantageously apply the micro-sized mouse-type input device to mobile electronic apparatuses.

### SUMMARY OF THE INVENTION

An aspect of the present invention provides a light detection-type input device having a simple structure without a separate lens or an image sensor by irradiating light from a light emitting unit onto a surface having a grid or an optical filter, sensing a reflection of the irradiated light from the surface through the grid or the optical filter, and sensing a coordinate of an object contacting the surface.

According to an aspect of the present invention, there is provided an input device including: a housing having a surface on which a plurality of grids are disposed; a light emitting unit irradiating light onto the surface of the housing; a light receiving element detecting the light irradiated from the light emitting unit and reflected from the surface; and a control unit determining information regarding an object contacting the surface from the light detected by the light receiving element.

The light emitting unit may include: a first light emitting unit and a second light emitting unit alternately turned on and irradiating light onto the surface.

The light receiving element may include a first light receiving element detecting the light irradiated from the first light emitting unit and reflected from the surface, and a second light receiving element detecting the light irradiated from the second light emitting unit and reflected from the surface.

The control unit may allow the first light emitting unit and the second light emitting unit to be alternately operated.

The control unit may determine a first axial coordinate of the object contacting the surface from the light detected by the first light receiving element, and a second axial coordinate of the object contacting the surface from the light detected by the second light receiving element.

The housing may include a reflective coating surface provided such that the light irradiated from the light emitting unit is reflected and is irradiated onto the surface thereof.

According to another aspect of the present invention, there is provided an input device including: a housing having a surface on which an optical filter is disposed; a light emitting unit irradiating light onto the surface of the housing; a light receiving element detecting the light irradiated from the light emitting unit and reflected from the surface; and a control unit determining information regarding an object contacting the surface from the light detected by the light receiving element.

The light emitting unit may include a plurality of light emitting units driven by the control unit, alternately irradiating light onto the surface, and disposed in different positions.

The plurality of light emitting units may irradiate the light having different characteristics.

The plurality of light emitting units may include first and second light emitting units facing each other in a first axial direction with respect to the surface, and third and fourth light emitting units facing each other in a second axial direction with respect to the surface.

The control unit may determine a coordinate of the object in the first axial direction from the light irradiated from the first and second light emitting units and reflected from the surface, and a coordinate of the object in the second axial direction from the light irradiated from the third and fourth light emitting units and reflected from the surface.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of an electronic apparatus to which an input device is applied according to an embodiment of the present invention;

FIGS. 2A through 2C are views, each illustrating an input device according to an embodiment of the present invention;

FIG. 3 is a schematic block diagram of the input device of FIGS. 2A through 2C;

FIG. 4 is a diagram for explaining a method of determining input information of an object performed by the input device of FIGS. 2A through 2C;

FIGS. 5A through 5C are views, each illustrating an input device according to another embodiment of the present invention;

FIG. 6 is a schematic block diagram of the input device of FIGS. 5A through 5C; and

FIG. 7 is a diagram for explaining a method of determining input information of an object performed by the input device of FIGS. 5A through 5C.

### DETAILED DESCRIPTION OF THE EMBODIMENTS

Embodiments of the present invention will now be described in detail with reference to the accompanying drawings. The present invention will now be described more fully with reference to the accompanying drawings, in which embodiments of the invention are shown. In the following detailed description, only certain exemplary embodiments of the present invention have been shown and described, simply by way of illustration. As those skilled in the art would realize, the described embodiments may be modified in various different ways, all without departing from the spirit or scope of the present invention. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. Like reference numerals denote same or like elements throughout.

Hereinafter, the present invention will be described in detail by explaining preferred embodiments of the invention with reference to the attached drawings so that the present invention would have been obvious to one of ordinary skill in the art.

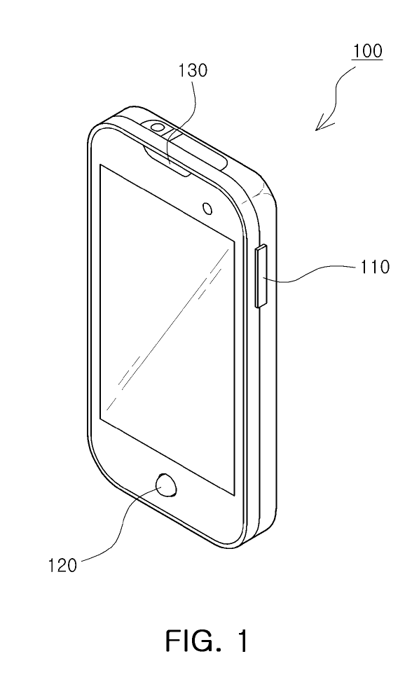

FIG. 1 is a perspective view of an electronic apparatus to which an input device is applied according to an embodiment of the present invention. Referring to FIG. 1, an electronic apparatus 100 according to the embodiment includes a display device 110 outputting a screen, an input device 120, and an audio unit 130 outputting sound, and may further include a contact sensing device integrally formed with the display device 110.

In the electronic apparatus 100, the contact sensing device is integrally formed with the display device 110 in general, and needs to have a high light transmittance in such a manner that the screen displayed by the display device 110 may be transmitted therethrough. Thus, the contact sensing device may be implemented by forming a sensing electrode made of a transparent, electric and conductive material such as indium-tin oxide (ITO), indium zinc oxide (IZO), zinc oxide (ZnO), carbon nano tube (CNT), or graphene on a base substrate made of a transparent film material such as polycarbonate (PC), polyethersulfone (PES), polyimide (PI), polyethylene terephthalate (PET), or the like. A wire pattern connected to the sensing electrode made of the transparent, electric and conductive material may be disposed in a bezel region of the display device 110. The wire pattern may be visually shield by the bezel region, and thus, formed of a metal material such as silver (Ag), copper (Cu), or the like.

The input device 120 may be provided in such a manner that it may be identified from the exterior of the electronic apparatus 100, and may be disposed in the front of a housing of the electronic apparatus 100 to provide a user with an input unit. Although the input device 120 is disposed in a lower portion of the display device 110 in FIG. 1, the input device 120 may be disposed in various positions. The input device 120 may have a small size and use properties that light generated from the inside thereof is reflected from an object in contact therewith to determine a change in a coordinate of the contacted object. Accordingly, the input device 120 may realize various input forms such as a cursor movement and an icon selection, like an optical mouse of a desktop computer.

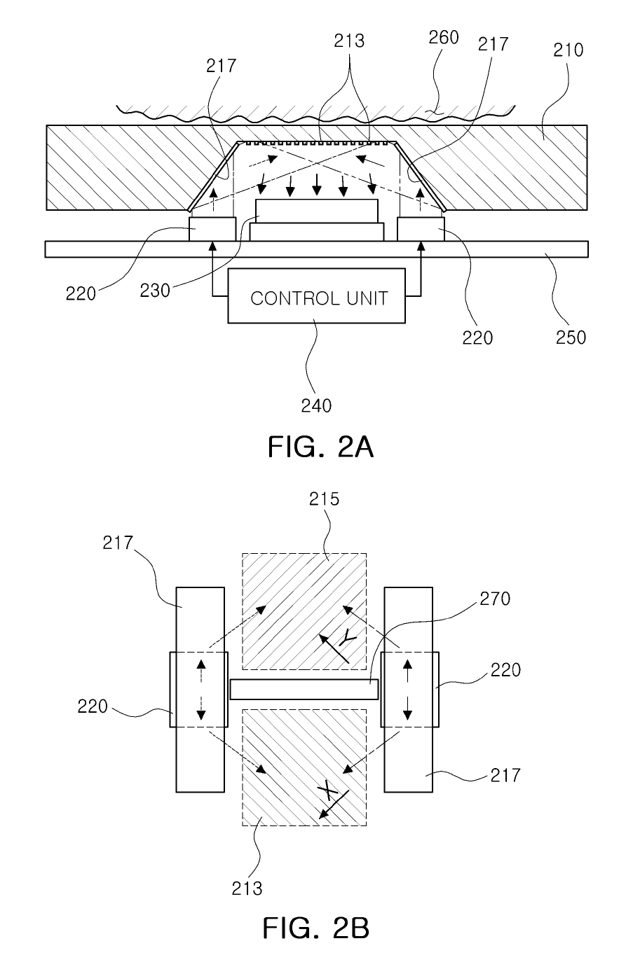

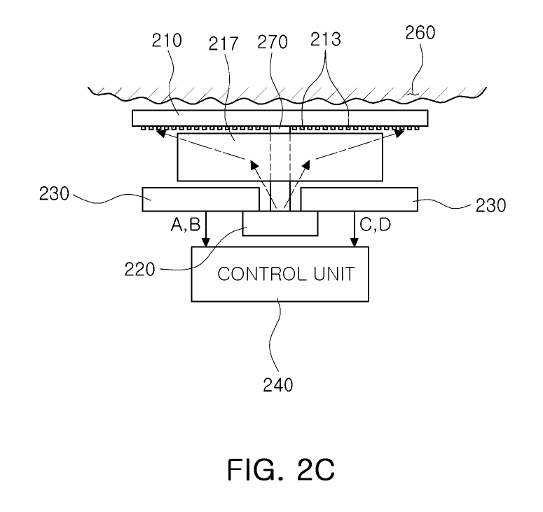

FIGS. 2A through 2C are views, each illustrating an input device according to an embodiment of the present invention.

Referring to FIGS. 2A through 2C, an input device 200 may according to the embodiment may include a housing 210 including first and second grids 213 and 215 extending in different directions, light emitting units 220 disposed below the housing 210, a light receiving element 230 detecting light irradiated from the light emitting unit 220 to the grids 213 and 215 to be reflected therefrom, a control unit 240, and the like.

Referring to FIG. 2A that is a plan view of the input device 200, an input object 260, such as a finger, contacts a specific surface 211 of the housing 210. The light irraidated from the light emitting units 220 is reflected from the input object 260 through the first grid 213 disposed on the surface 211 of the housing 210 and is incident onto the light receiving element 230. The control unit 240 may determine information regarding the input object 260 from the light incident onto the light receiving element 230 and detected therefrom.

The light emitting units 220 are disposed below the housing 210 and may be symmetrically disposed in the left and right of the light receiving element 230. The housing 210 may include reflective coating surfaces 217 provided on surfaces thereof, adjacent to the light emitting units 220, in order to allow light emitted from the light emitting units 220 to be incident onto the grid 213 provided on the surface 211 of the housing 210. The light emitting units 220 may be implemented as a plurality of light emitting diodes (LEDs).

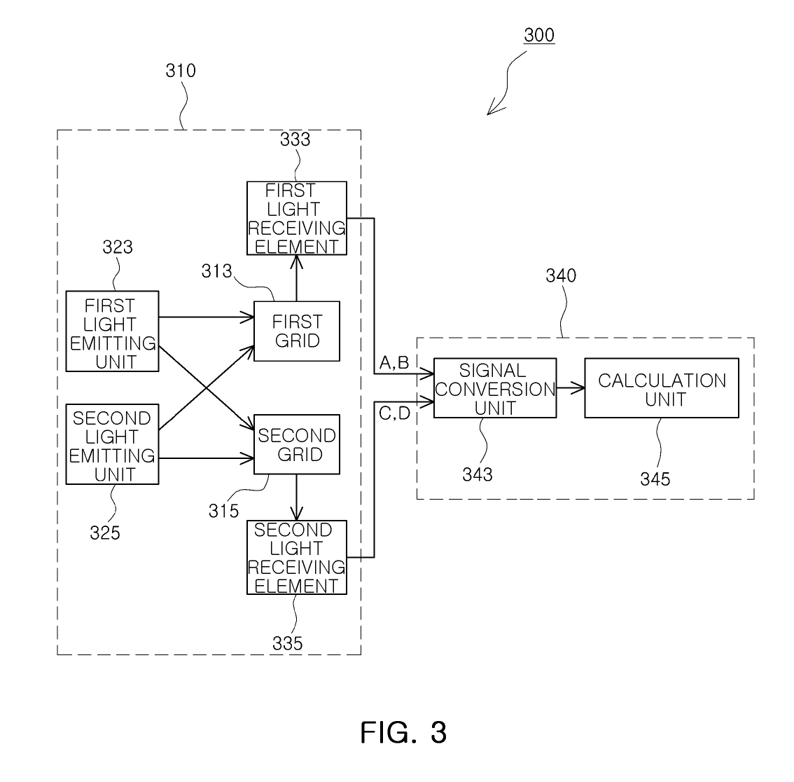

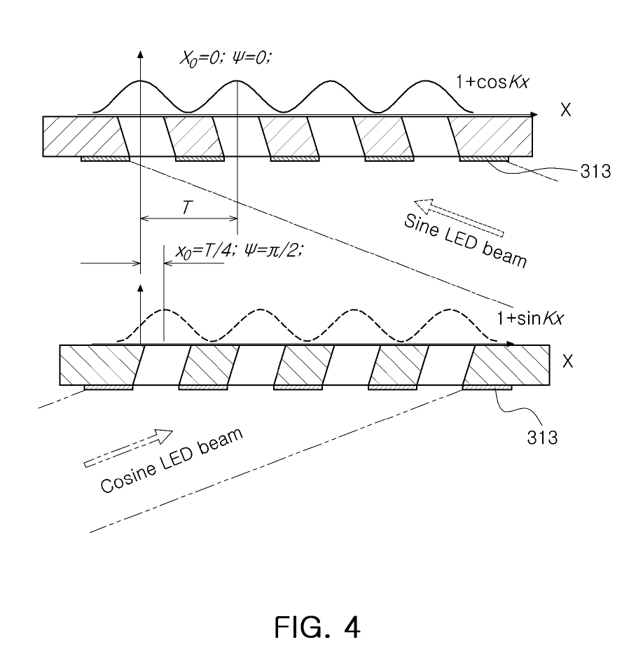

The light receiving element 230 may include a photo diode (PD), or the like, and may be mounted on a circuit substrate 250, together the light emitting units 220. The control unit 240 may also be disposed on the circuit substrate 250, and may be electrically connected to the light emitting units 220 and the light receiving element 230 through a circuit pattern on the circuit substrate 250. The control unit 240 may allow the light emitting units 220 disposed in the left and right of the light receiving element 230 to be alternately driven to thereby emit light. That is, when the light emitting unit 220 disposed in the right of the light receiving element 230 emits light, the light emitting unit 220 disposed in the left of the light receiving element 230 is turned off and does not emit light. Meanwhile, when the light emitting unit 220 disposed in the left of the light receiving element 230 emits light, the light emitting unit 220 disposed in the right of the light receiving element 230 is turned off and does not emit light. The light emitted from the light emitting unit 220 disposed in the left of the light receiving element 230 and the light emitted from the light emitting unit 220 disposed in the right of the light receiving element 230 have different characteristics. This will be described later with reference to FIGS. 3 and 4.

Referring to FIGS. 2B and 2C that are respectively top and side views of the input device 200, a predetermined barrier wall 270 may be disposed between the first grid 213 and the second grid 215. The light alternately emitted from the respective light emitting units 220 may be used to determine a first axial direction coordinate and a second axial direction coordinate of the input object 260 by being independently reflected from the first grid 213 and the second grid 215. To this end, the barrier wall 270 may be disposed between the first grid 213 and the second grid 215.

Also, as shown in FIG. 2C, the light receiving element 230 may be divided into a first light receiving element 233 and a second light receiving element 235 by the barrier wall 270. Referring to FIGS. 2B and 2C, the input device 200 may include the first light receiving element 233 detecting light reflected through the first grid 213 and the second light receiving element 235 detecting light reflected through the second grid 215. The control unit 240 may independently perform processing on the light detected by the first light receiving element 233 and the light detected by the second light receiving element 235 and determine the first axial direction coordinate (an X-axial coordinate) and the second axial direction coordinate (a Y-axial coordinate) of the input object 260.

FIG. 3 is a schematic block diagram of an input device of FIGS. 2A through 2C.

Referring to FIG. 3, the input device 300 according to the embodiment may be divided into an optical unit 310 and a control unit 340. The optical unit 310 may include grids 313 and 315, light emitting units 323 and 325, and light receiving elements 333 and 335. The control unit 340 may include a signal conversion unit 343 and a calculation unit 345. A process of determining input information regarding an object performed by the input device of FIG. 2 will now be described with reference to FIGS. 3 and 4.

As described above, the light emitting units 323 and 325 may be alternately driven to irraidated light onto the respective grids 313 and 315. Light emitted from the first light emitting unit 323 that is activated, maybe reflected from an input object through the first grid 313 and the second grid 315, and be incident onto the first light receiving element 333 and the second light receiving element 335. At this time, the second light emitting unit 325 becomes inactivated. Meanwhile, light is emitted from the second light emitting unit 325 that is activated, may be reflected from the input object through the first grid 313 and the second grid 315, and be incident onto the first light receiving element 333 and the second light receiving element 335. At this time, the first light emitting unit 323 becomes inactivated.

The control unit 340 controls the first light emitting unit 323 and the second light emitting unit 325 such that they emit light having different characteristics. For example, the light emitted from the first light emitting unit 323 and the light emitted from the second light emitting unit 325 may have the same period, the same propagation constant, and the same waveform, but may have different phases. Thus, when the light emitted from the first light emitting unit 323 is defined by a sine graph of a trigonometric function, the light emitted from the second light emitting unit 325 may be defined by a cosine graph having a phase difference of π/2 from the light emitted from the first light emitting unit 323.

FIG. 4 is a view illustrating light reflected through the first grid 313 of a housing when the first light emitting unit 323 emitting light defined by a sine wave is activated and when the second light emitting unit 325 emitting light defined by a cosine wave is activated. When the light emitted from the activated first light emitting unit 323 is reflected through the first grid 313 of the housing, a phase difference occurs in the reflected light according to a distance between a valley and a ridge of the first grid 313. In a similar manner, when the light emitted from the activated second light emitting unit 325 is reflected through the first grid 313, a phase difference occurs in the reflected light according to a distance between a valley and a ridge of the first grid 313.

The phase differences that occur during a process in which the light emitted from the respective light emitting units 323 and 325 is reflected through the respective grids 313 and 315 may be determined according to distances between valleys and ridges of the grids 313 and 315, i.e., periods of the grids 313 and 315. The grids 313 and 315 maybe disposed on a surface contacting an input object or inside the housing in an in-moulding scheme. The grids 313 and 315 may be formed of an opaque material and provided in the housing having excellent light transmittance.

Through the process shown in FIG. 4, light detected by the first light receiving element 333 and the second light receiving element 335 may be expressed according to Equations 1 and 2 below.

A=U_{X1}+V_{X1} sin Kx

C=U_{X2}+V_{X2} cos Kxₛ [Equation 1]

B=U_{Y1}+V_{Y1} sin Kyₛ

D=U_{Y2}+V_{Y2} cos Kyₛ [Equation 2]

In Equations 1 and 2 above, A and C are light detected by the respective light receiving elements 333 and 335 by being emitted from the first light emitting unit 323 and being reflected through the grids 313 and 315, and B and D are light detected by the respective light receiving elements 333 and 335 by being emitted from the second light emitting unit 325 and being reflected through the grids 313 and 315. That is, A is light emitted from the first light emitting unit 323 and detected by the first light receiving element 333, B is light emitted from the second light emitting unit 325 and detected by the first light receiving element 333, C is light emitted from the first light emitting unit 323 and detected by the second light receiving element 335, and D is light emitted from the second light emitting unit 325 and detected by the second light receiving element 335. In this regard, K denotes a propagation constant given as 2 π/T. T denotes a period in which the grids 313 and 315 are formed. U_{X}, U_{Y}, V_{X}, and V_{Y} included in Equations 1 and 2 above may be determined according to power of LEDs included in the light emitting units 323 and 325.

The signal conversion unit 343 of the control unit 340 converts an electrical signal into a digital signal according to the light periodically detected by the light receiving elements 333 and 335. The calculation unit 345 calculates a difference value between a signal converted in a previous timing and a currently detected signal. The difference value is calculated for each signal with regard to A-D and may be expressed as ΔA˜ΔD. The calculation unit 345 may calculate the movement of the input object from the difference values ΔA˜ΔD of respective signals and the difference values ΔA˜ΔD of respective signals may be expressed according to Equation 3 below.

$$Δ {A}_{n} = {A}_{n} - {A}_{n - 1} = Δ {x [ \frac{\partial A}{\partial x} ]}_{A = {A}_{n}} = Δ {xV}_{X 1} K cos {Kx}_{n} \\ Δ {B}_{n} = {B}_{n} - {B}_{n - 1} = Δ {y [ \frac{\partial B}{\partial x} ]}_{B = {B}_{n}} = Δ {yV}_{Y 1} K cos {Ky}_{n} \\ Δ {C}_{n} = {C}_{n} - {C}_{n - 1} = Δ {x [ \frac{\partial C}{\partial x} ]}_{C = {C}_{n}} = - Δ {xV}_{X 2} K sin {Kx}_{n} \\ Δ {D}_{n} = {D}_{n} - {D}_{n - 1} = Δ {y [ \frac{\partial D}{\partial y} ]}_{D = {D}_{n}} = - Δ {yV}_{Y 2} K sin {Ky}_{n} \qquad [ Equation 3 ]$$

x and y coordinates in a timing in which coordinates are calculated from Equation 3 are calculated as in Equation 4 below. Through the above process, an input device capable of determining a coordinate, a movement, a gesture, and the like, of an input object maybe implemented, without a lens requiring a relatively large space and an expensive image sensor.

$${X}_{n} = \frac{1}{K} arctan [ - \frac{{C}_{n} - {C}_{n - 1}}{{A}_{n} - {A}_{n - 1}} ] = \frac{T}{2 π} arctan [ \frac{{V}_{X 2}}{{V}_{X 1}} tan {Kx}_{n} ] \\ {Y}_{n} = \frac{1}{K} arctan [ - \frac{{D}_{n} - {D}_{n - 1}}{{B}_{n} - {B}_{n - 1}} ] = \frac{T}{2 π} arctan [ \frac{{V}_{Y 2}}{{V}_{Y 1}} tan {Ky}_{n} ] \qquad [ Equation 4 ]$$

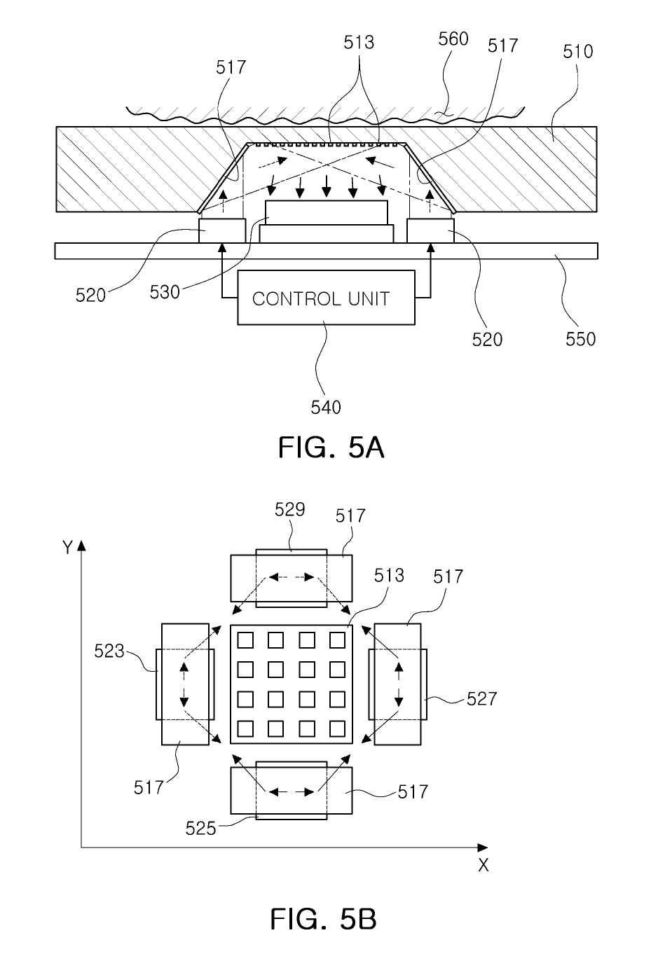

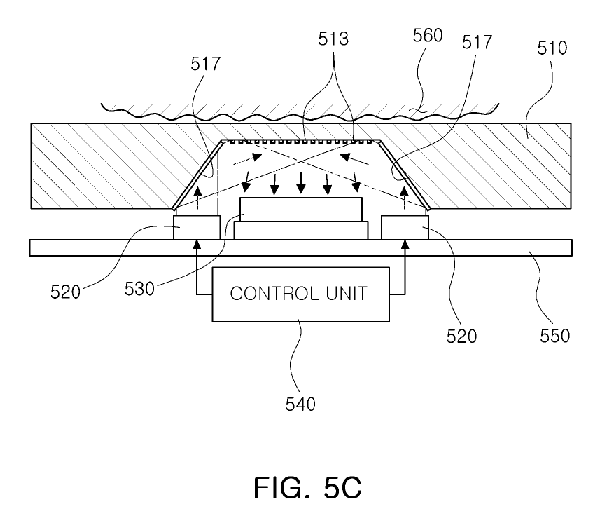

FIGS. 5A through 5C are views, each illustrating an input device according to another embodiment of the present invention.

Referring to FIGS. 5A through 5C, an input device 500 according to the embodiment includes a housing 510 on which an optical filter 513 is formed, rather than the grids 213 and 215, unlike the input device 200 of FIG. 2. In addition, the input device 500 may include light emitting units 520 disposed below the housing 510, a light receiving element 530 detecting light irradiated from the light emitting units 520 to the optical filter 513 and reflected therefrom, and a control unit 540.

Referring to FIG. 5A that is a plan view of the input device 500, an input object 560, such as a finger, contacts a specific surface 511 of the housing 510. The light irraidated from the light emitting units 520 is reflected from the input object 560 through the optical filter 513 disposed on the surface 511 of the housing 510 and is incident onto the light receiving element 530. The control unit 540 may determine information regarding the input object 560 from the light incident onto the light receiving element 530 and detected therefrom.

The light emitting units 520 may be disposed below the housing 510 and may be symmetrically disposed in the left and right of the light receiving element 530. The housing 510 may include reflective coating surfaces 517 provided on surfaces thereof, adjacent to the light emitting units 520, in order to allow light emitted from the light emitting units 520 to be incident onto the optical filter 513 provided on the surface 511 of the housing 510. The light emitting units 520 may be implemented as a plurality of LEDs.

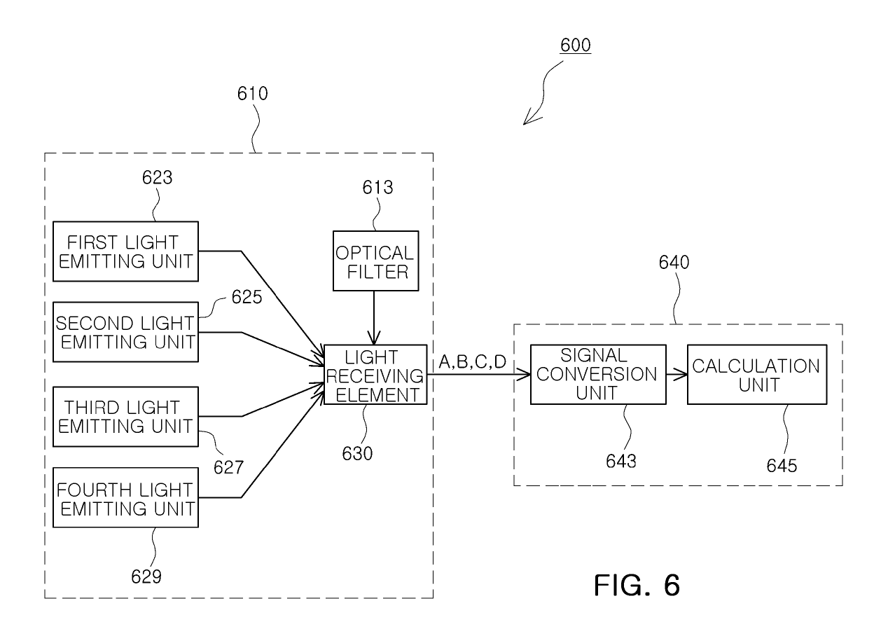

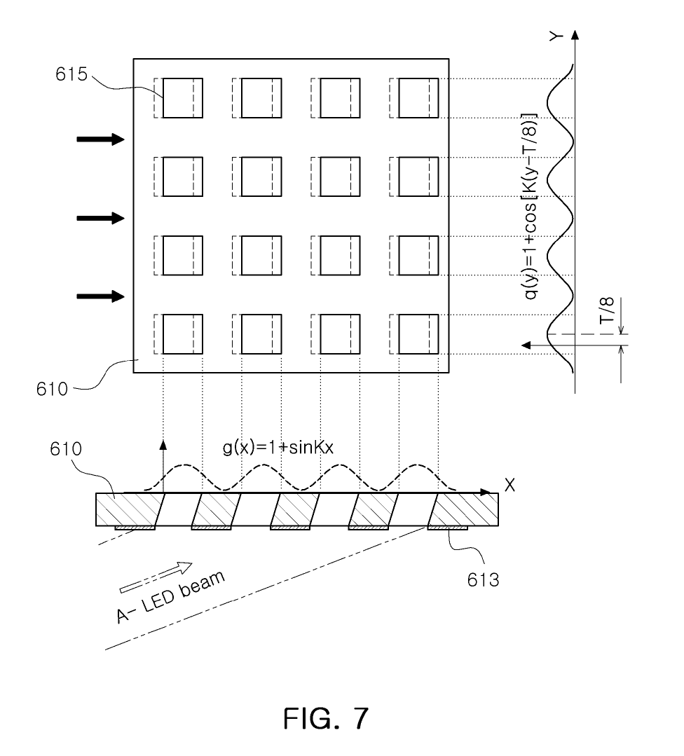

The light receiving element 530 may include a photo diode (PD), or the like, and may be mounted on a circuit substrate 550, together the light emitting units 520. The control unit 540 may also be disposed on the circuit substrate 550, and may be electrically connected to the light emitting unit 520 and the light receiving element 530 through a circuit pattern on the circuit substrate 550. The control unit 540 may allow a plurality of the light emitting units 520 disposed around the light receiving element 530 to be alternately driven to thereby emit light. The light emitted from the light emitting unit 520 disposed in the left of the light receiving element 530 and the light emitted from the light emitting unit 520 disposed in the right of the light receiving element 530 have different characteristics. This will be described later with reference to FIGS. 6 and 7.

Referring to FIGS. 5B and 5C that are respectively top and side views of the input device 500, first to fourth light emitting units 523, 525, 527, and 529 may be disposed in the top, bottom, left and right of the optical filter 513. As described above, the light emitting units 523, 525, 527, and 529 may be alternately driven separately. For example, the control unit 540 may determine an X-axial direction coordinate of the input object 560 from light emitted from the first light emitting unit 523 and the third light emitting unit 527 and detected by the light receiving element 530, and a Y-axial direction coordinate of the input object 560 from light emitted from the second light emitting unit 525 and the fourth light emitting unit 529 and detected by the light receiving element 530.

FIG. 6 is a schematic block diagram of an input device of FIGS. 5A through 5C.

Referring to FIG. 6, the input device 600 maybe divided into an optical unit 610 and a control unit 640. The optical unit 610 may include an optical filter 613, first to fourth light emitting units 623, 625, 627, and 629, and a light receiving element 633. The control unit 640 may include a signal conversion unit 643 and a calculation unit 645. A process of determining input information regarding an object performed by the input device of FIG. 5 will now be described with reference to FIGS. 6 and 7.

As described above, the light emitting units 623, 625, 627, and 629 are alternately driven to irraidated light onto the optical filter 613. Since the light emitting units 623, 625, 627, and 629 are disposed in different positions with respect to the optical filter 613, if light irradiated from the respective light emitting units 623, 625, 627, and 629 is reflected through the optical filter 613, the light has different characteristics. This will now be described with reference to FIG. 7 in which it is assumed that light is irradiated from the first light emitting unit 623.

Referring to FIG. 7, light is irradiated from the first light emitting unit 623 disposed in the left of the optical filter 613 and is reflected through the optical filter 613. In this regard, provided that light incident from the first light emitting unit 623 is defined by q(y), and light reflected through the optical filter 613 and detected by the light receiving element 630 is defined by g(x), q(y) and g(x) are expressed according to Equations 5 and 6 below.

q(y)=1+cos[K(y−T/8)]

g(x)=1+sin Kx [Equation 5]

As described above, K denotes a propagation constant, and T denotes a period. In Equation 5, a signal converted by the signal conversion unit 643 may be approximated in the same manner as A of Equation 1. As a result, in the input device 600 including the optical filter 613, rather than grids, shown in FIGS. 5A through 6, a method of calculating a coordinate in the calculation unit 645 maybe derived from Equations 1 through 4 in the same manner.

In the case in which the first light emitting unit 623 irradiates light, A of Equation 1 may be obtained by the light receiving element 630. In the case in which the third light emitting unit 627 irradiates light, C of Equation 1 may be obtained by the light receiving element 630. Likewise, in the case in which the second and fourth light emitting units 625 and 629 irradiate light, the respective B and D of Equation 2 may be obtained. The calculation unit 645 may calculate a coordinate of an input object using the values of A˜D detected by the light receiving element 630 and Equations 3 and 4.

As set forth above, according to the embodiments of the invention, a light detection-type input device having a simple structure without a separate lens or an image sensor by irradiating light from a light emitting unit onto a surface having a grid or an optical filter, sensing a reflection of the irradiated light from the surface through the grid or the optical filter, and sensing a coordinate of an object contacting the surface can be provided, and thus, a price rise thereof can be prevented by using a light receiving element like a photo diode other than an image sensor.

While the present invention has been shown and described in connection with the embodiments, it will be apparent to those skilled in the art that modifications and variations can be made without departing from the spirit and scope of the invention as defined by the appended claims.

What is claimed is:

1. An input device comprising:
a housing having a surface on which a plurality of grids are disposed;
a light emitting unit irradiating light onto the surface of the housing;
a light receiving element detecting the light irradiated from the light emitting unit and reflected from the surface; and
a control unit determining information regarding an object contacting the surface from the light detected by the light receiving element.

2. The input device of claim 1, wherein the light emitting unit includes a first light emitting unit and a second light emitting unit alternately turned on and irradiating light onto the surface.

3. The input device of claim 2, wherein the light receiving element includes a first light receiving element detecting the light irradiated from the first light emitting unit and reflected from the surface, and a second light receiving element detecting the light irradiated from the second light emitting unit and reflected from the surface.

4. The input device of claim 2, wherein the control unit allows the first light emitting unit and the second light emitting unit to be alternately operated.

5. The input device of claim 3, wherein the control unit determines a first axial coordinate of the object contacting the surface from the light detected by the first light receiving element, and a second axial coordinate of the object contacting the surface from the light detected by the second light receiving element.

6. The input device of claim 1, wherein the housing includes a reflective coating surface provided such that the light irradiated from the light emitting unit is reflected and is irradiated onto the surface thereof.

7. An input device comprising:
a housing having a surface on which an optical filter is disposed;
a light emitting unit irradiating light onto the surface of the housing;
a light receiving element detecting the light irradiated from the light emitting unit and reflected from the surface; and
a control unit determining information regarding an object contacting the surface from the light detected by the light receiving element.

8. The input device of claim 7, wherein the light emitting unit includes a plurality of light emitting units driven by the control unit, alternately irradiating light onto the surface, and disposed in different positions.

9. The input device of claim 8, wherein the plurality of light emitting units irradiate the light having different characteristics.

10. The input device of claim 8, wherein the plurality of light emitting units include first and second light emitting units facing each other in a first axial direction with respect to the surface, and third and fourth light emitting units facing each other in a second axial direction with respect to the surface.

11. The input device of claim 10, wherein the control unit determines a coordinate of the object in the first axial direction from the light irradiated from the first and second light emitting units and reflected from the surface, and a coordinate of the object in the second axial direction from the light irradiated from the third and fourth light emitting units and reflected from the surface.
